(19) United States
(12) Patent Application Publication
(10) Pub. No.: US 2025/0256971 A1
(43) Pub. Date: Aug. 14, 2025

(54) Compositions and Methods for the Capture of Carbon Dioxide and/or the Generation of Silica

(71) Applicant: OHIO STATE INNOVATION FOUNDATION, Columbus, OH (US)

(72) Inventors: Shang ZHAI, Columbus, OH (US); Liang-Shih FAN, Columbus, OH (US); Kyle SHANK, Columbus, OH (US); David COLE, Columbus, OH (US)

(21) Appl. No.: 19/052,136

(22) Filed: Feb. 12, 2025

Related U.S. Application Data
(60) Provisional application No. 63/552,642, filed on Feb. 12, 2024.

(51) Int. Cl. C01B 33/12; C01B 3/06; C01F 5/24; C01F 11/18

(52) U.S. Cl. CPC C01B 33/126; C01B 3/061; C01F 5/24; C01F 11/18

(57) ABSTRACT

Described herein are methods of using silicate materials, including silicate materials obtained from nature, synthesized, and/or obtained from industrial waste streams, to capture and store carbon dioxide. In some embodiments, the methods can also be used to form silica (e.g., high purity silica). In some embodiments, the methods can also be used to produce hydrogen.

### CROSS-REFERENCE TO RELATED APPLICATIONS

This application claims benefit of priority of U.S. Provisional Application No. 63/552,642, filed Feb. 12, 2024, which is hereby incorporated by reference in its entirety.

### BACKGROUND

Rising levels of carbon dioxide (CO₂) in the Earth's atmosphere, caused primarily by combustion of fossil fuels, have prompted concern that temperatures at the Earth's surface will increase sharply during the 20th century. To address this issue, numerous nations are developing plans for lowering CO₂ emissions to the atmosphere. The principal approaches under consideration are: improving energy efficiency; making greater use of alternative sources of energy; and developing economical viable technologies for capture, separation, and long-term storage of CO₂. The latter strategy, known as “CO₂ sequestration,” is receiving increasing attention because it permits continued use of high-carbon fossil fuels to generate electrical power while ensuring that CO₂ releases to the atmosphere are reduced. However, to execute this strategy, improved processes for capture, separation, and long-term storage of CO₂ are needed.

### SUMMARY

Described herein are methods of using silicate materials (e.g., obtained from nature, synthesized, or obtained from an industrial waste stream) to capture and store CO₂. In some embodiments, the methods can also be used to form supplementary cementitious materials such as silica and carbonated steel slag. In some embodiments, the methods can also be used to produce hydrogen.

For example, provided herein are methods and processes in which CO₂ and a silicate material act as major inputs, and as are used to produce stable, non-soluble carbonate, silica, and hydrogen as major outputs. A soluble (bi) carbonate can serve as an intermediate substance consumed and regenerated in the process.

By way of example, in some embodiments, the methods and processes described herein can comprise at least three steps. In certain embodiments, the methods and processes described herein can comprise four steps.

In some embodiments, the methods and processes can comprise an optional first step in which a silicate feedstock (e.g., obtained from nature, synthesized, or obtained from an industrial waste stream), such as a silicate that comprises a reduced metal cation or metal (e.g., a transition metal or reduced transition metal cation such as Fe metal or an Fe²⁺ ion), is reacted with water vapor at an elevated temperature to generate a hydrogen gas product. The elevated temperature employed in the first step can vary depending upon the identity of silicate. At the same time, the water vapor-oxidized silicate feedstock can be used as a silicate precursor in a subsequent reaction step. Alternatively, in other embodiments, this step is optional, and the silicate feedstock can be directly used in the subsequent reaction steps.

In some embodiments, the methods and processes can comprise a solution-based carbonation reaction. In some embodiments, the methods and processes can comprise a second step in which a silicate precursor is reacted with a carbonate or bicarbonate solution at an alkaline pH value to form stable non-soluble carbonate precipitate and soluble silicate product. By way of example, the second step can comprise a reaction such as the following:

CaSiO₃(s)+Na₂CO₃(aq.)↔CaCO₃(s)+Na₂SiO₃(aq.)

In some embodiments, the methods and processes can further comprise a carbon dioxide capture reaction. In some embodiments, the methods and processes can comprise a third step in which the soluble silicate product from the second step is reacted with gaseous carbon dioxide (e.g., at various concentrations) in a liquid solution (e.g., an aqueous solution) to form a soluble carbonate or bicarbonate and silicic acid. By way of example, the third step can comprise a reaction such as the following:

Na₂SiO₃(aq.)+CO₂+H₂O↔Na₂CO₃(aq.)+H₂SiO₃(s).

In some embodiments, the methods and processes can further comprise a thermal decomposition reaction. In some embodiments, the methods and processes can comprise a fourth step in which the silicic acid can be thermally decomposed to silica and water vapor.

In the methods and processes described herein, the second step, the third step, and the fourth step, together, can provide a process or method whereby a silicate (e.g., a calcium silicate) and carbon dioxide are reacted to produce a stable, aqueous insoluble carbonate (e.g., calcium carbonate) and silica. The processes and methods described herein can thus be used to capture carbon dioxide (a greenhouse gas) and react the carbon dioxide to generate a stable carbonate. This stable carbonate can serve as a carbon dioxide sink (sequestering the carbon dioxide and removing it from the atmosphere in a solid form). The resulting silica product generated by the processes and methods described herein can be of high purity, and can serve as an industrial feedstock for industries including the construction, semiconductor and glass industries.

Depending upon the choice of feedstock, the methods and processes described herein can also utilize silicate industrial waste (e.g., steel slag, fly ash, etc.), producing valuable end products from these waste streams.

In some embodiments of the methods and processes described herein, the process can produce hydrogen (e.g., without attendant greenhouse gas emissions).

### DESCRIPTION OF DRAWINGS

FIG. 1A is an illustration of an example basic oxygen furnace (BOF) steel slag generation process.

FIG. 1B is a schematic illustration of hydrogen (H₂) production and carbon dioxide (CO₂) mineralization of BOF steel slag through sodium carbonate looping.

FIG. 2A is a plot showing H₂ production from water (H₂O) with BOF steel slags. Experiments were conducted with 6 g steel slag at 600° C. and 2 sccm H₂O mixed with 98 sccm Argon (Ar). Recycled endpoint slag is typically recycled in the blast furnace. Skimmed slag was scooped directly out of the BOF. Mixed waste was unrecyclable slag waste from the BOF. Aged waste was also unrecyclable waste but aged outside for an unknown period.

FIG. 2B is a plot showing the X-ray Absorption Near Edge Structure (XANES) for Iron (Fe) K-edge showing the Fe oxidation state increase for skimmed slag after reacting with H₂O to produce H₂.

FIG. 3A is a schematic illustration of ten sodium carbonate looping cycles of point source CO₂ capture with skimmed BOF slag at 45° C. 0.5 g of steel slag per cycle with 90 sccm 4% CO₂/Ar. The solid trace is the uncaptured CO₂ compared to the dashed trace representing the supply gas mixture.

FIG. 3B is a plot of thermogravimetric analysis (TGA) and CO₂ evolution of carbonated steel slag from a “baseline method” with steel slag and water mixture capturing 4% CO₂.

FIG. 3C is a plot of TGA and CO₂ evolution of carbonated steel slag from sodium carbonate looping capturing 4% CO₂, showing 1.9 times higher CO₂ sequestration than the baseline shown in FIG. 3B.

FIG. 3D is a schematic illustration of ten sodium carbonate looping cycles of direct air capture (DAC) with skimmed BOF slag at 45° C. 0.05 g of steel slag per cycle with 90 sccm of 343 ppm CO₂/Ar.

FIG. 3E is a plot of TGA and CO₂ evolution of carbonated steel slag from a baseline method with steel slag and water mixture capturing 343 ppm CO₂.

FIG. 3F is a plot of TGA and CO₂ evolution of carbonated steel slag from DAC sodium carbonate looping, showing 5.2 times higher CO₂ sequestration than the baseline shown in FIG. 3E.

FIG. 3G is a plot showing a comparison of CO₂ capture capacity and CO₂ conversion by skimmed slag for 20% CO₂, 4% CO₂, and 343 ppm CO₂ (DAC) at 45° C. and room temperature (24° C.).

FIG. 3H is a plot showing the CO₂ capture capacity of different BOF slags for 4% CO₂ at 45° C. Skimmed-No H₂ is skimmed slag that did not react with water for H₂ production prior to sodium carbonate looping.

FIG. 4A is a plot of x-ray diffraction (XRD) comparing unreacted skimmed BOF slag with baseline slag and sodium carbonate looping slag after 10 cycles with 4% CO₂ at 45° C. (Mg_{0.593}Fe_{0.407})O was oxidized to Mg_{0.64}Fe_{2.36}O₄ by reacting with steam. There were higher conversions of Ca₂SiO₄, Ca₃SiO₅, and CaO to CaCO₃ after CO₂ capture by sodium carbonate looping compared to by the baseline method.

FIG. 4B is plot showing calcium (Ca) and silicon (Si) concentration evolution in aqueous solution during dissolution of skimmed slag in water for 150 min, followed by addition of sodium carbonate. The dissolution of skimmed steel slag in water results in the release of Ca into the solution from phases such as Ca-silicates and CaO. Upon the addition of sodium carbonate, the dissolved calcium reacts to precipitate CaCO₃ and silicates release into the solution was significantly enhanced. Ca and Si concentrations were measured by Inductively Coupled Plasma Optical Emission Spectrometry (ICP-OES) and Ultraviolet-Visible Spectroscopy (UV-VIS), respectively.

FIG. 4C shows Scanning Electron Microscopy (SEM) and Energy Dispersive X-Ray Spectroscopy (EDS) maps that compare the distribution of Ca, Si, and carbon (C) in unreacted skimmed steel slag, after 10 cycles of capturing 4% CO₂ at 45° C. by the baseline method, and after 10 cycles of capturing 4% CO₂ at 45° C. by sodium carbonate looping. Elemental mapping of C and Si reveals a higher degree of carbon sequestration by sodium carbonate looping than the baseline method, with C replacing Si in the slag.

FIG. 5A is a schematic of a proposed plant design for hydrogen production and CO₂ mineralization with BOF steel slag through sodium carbonate looping.

FIG. 5B shows the results of a technoeconomic analysis (TEA) comparing sodium carbonate looping to the baseline process for capturing 4% CO₂. The process cost was evaluated for different energy (purely electricity) supply methods, including solar grid, solar PV with 16-hour battery storage, wind turbine with 16-hour battery storage, and a steam power plant using waste heat from the slag. The levelized costs of electricity are noted in parentheses. The revenue streams from hydrogen (H₂), precipitated silica (SiO₂), carbonated steel slag, and the 45Q tax credit are presented on the right axis.

FIG. 5C shows the results of a TEA for direct air capture (DAC) sodium carbonate looping compared to the baseline process. The steam power plant scenario uses waste heat from the slag and is supplemented by solar grid electricity

FIG. 6A is a plot of XRD of amorphous precipitated SiO₂ compared to quartz wool as a reference.

FIG. 6B shows SEM and EDS of precipitated SiO₂ showing composition is silicon and oxygen. Sample preparation was done with 19 g of skimmed slag carbonated in an aqueous solution of 47 g of Na₂CO₃ in 900 mL DI H₂O for 12 hours at 60° C. and 80 rpm. The mixture was then filtered, and the solution was subject to 48 hours of 90 sccm pure CO₂ to precipitate SiO₂.

FIG. 7 is a flow chart illustrating Cleveland Cliffs-Cleveland Works BOF slag processing.

FIG. 8 is a schematic illustration of four experimental cases for CO₂ capture performance.

FIG. 9A is a schematic representation of the processes and methods described herein.

FIG. 9B shows the XRD pattern of the products obtained from Steps 1 and 2 in FIG. 9A.

### DETAILED DESCRIPTION

### Definitions

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

As used herein, the singular forms “a”, “an” and “the” are intended to include the plural forms as well, unless the context clearly indicates otherwise. The use of “or” is intended to include “and/or”, unless the context clearly indicates otherwise. Additionally, the use of “and” is intended to encompass “and/or,” unless the context clear indicates otherwise.

As used herein, “about” is a term of approximation and is intended to include minor variations in the literally stated amounts, as would be understood by those skilled in the art. Such variations include, for example, standard deviations associated with techniques commonly used to measure the recited amounts.

All of the numerical values contained in this disclosure are to be construed as being characterized by the above-described modifier “about,” are also intended to include the exact numerical values disclosed herein. The ranges disclosed herein should be construed to encompass all values within the upper and lower limits of the ranges, unless indicated otherwise. Moreover, all ranges include the upper and lower limits.

By “contact” or other forms of the word, such as “contacted” or “contacting,” is meant to add, combine, or mix two or more compounds, compositions, components, or materials under appropriate conditions to produce a desired product or effect (e.g., to induce a particular chemical reaction). The terms “react” and “contacting” are synonymous herein when the acting of contacting two or more compounds, compositions, components, or materials results in a chemical reaction.

### Processes and Methods

Described herein are methods of using silicate materials (e.g., obtained from nature, synthesized, or obtained from an industrial waste stream) to capture and store CO₂ (e.g., via direct air capture and/or capture from a point source. In some embodiments, the methods can also be used to form silica (e.g., high purity silica). In some embodiments, the methods can also be used to produce hydrogen via a (bi) carbonate solution reaction cycle.

For example, provided herein are methods and processes in which CO₂ and a silicate material act as major inputs, and as are used to produce stable, non-soluble carbonate, silica, and hydrogen as major outputs. A soluble (bi) carbonate can serve as an intermediate substance consumed and regenerated in the process.

By way of example, in some embodiments, the methods and processes described herein can comprise at least three steps. In certain embodiments, the methods and processes described herein can comprise four steps.

In some embodiment, the methods and processes described herein can comprise (a) reacting a silicate precursor with an aqueous carbonate or bicarbonate solution having an alkaline pH under conditions effective to generate a stable carbonate precipitate and soluble silicate product; (b) reacting the soluble silicate product with carbon dioxide under conditions effective to form a soluble carbonate or bicarbonate and silicic acid; and (c) thermally decomposing the silicic acid to produce silica and water.

The silicate precursor can comprise any suitable silicate precursor described below. In some embodiments, the silicate precursor is selected from the group consisting of a nesosilicate, a sorosilicate, an inosilicate (a single chain inosilicate or a double chain inosilicate), a cyclosilicate, a phyllosilicate, or a tectosilicate.

In some embodiments, the silicate precursor can comprise an industrial waste material that comprises a silicate (e.g., a magnesium and/or calcium silicate), such as fly ash, incinerated ash, slag, or any combination thereof. Optionally, this material can be processed (e.g., subjected to steam treatment as described herein) prior to being reacted in step (a).

In certain embodiments, the silicate precursor comprises a calcium silicate. In certain eb the calcium silicate comprises wollastonite or pseudo-wollastonite.

The alkaline pH can be any suitable alkaline pH. If desired, any suitable alkaline agent or combination of alkaline agents can be added to the aqueous carbonate or bicarbonate solution to adjust the pH of the aqueous carbonate or bicarbonate solution as desired.

In some embodiments, the alkaline pH comprises a pH of 8 or more (e.g., 8.5 or more, 9 or more, 9.5 or more, 10 or more, 10.5 or more, 11 or more, 11.5 or more, 12 or more, 12.5 or more, 13 or more, or 13.5 or more). In some embodiments, the alkaline pH comprises a pH of 14 or less (e.g., 13.5 or less, 13 or less, 12.5 or less, 12 or less, 11.5 or less, 11 or less, 10.5 or less, 10 or less, 9.5 or less, 9 or less, or 8.5 or less).

The alkaline pH can comprise a pH ranging from any of the minimum values described above to any of the maximum values described above. For example, in some embodiments, the alkaline pH can comprise a pH of from 8 to 14, a pH of from 9 to 14, a pH of from 8 to 13, a pH of from 9 to 13, a pH of from 8 to 12, or a pH of from 9 to 12.

In some embodiments, the stable carbonate precipitate comprises calcium carbonate, magnesium carbonate, iron carbonate, or a combination thereof. In certain embodiments, the stable carbonate precipitate comprises calcium carbonate, magnesium carbonate, or a combination thereof.

In some embodiments, the stable carbonate precipitate can comprise transition metal ions present in the silicate precursor. In such embodiments, these transition metal ions can be precipitated (e.g., as a salt) with the stable carbonate precipitate. This can allow transition metal ions present within the silicate precursor to also be sequestered. In certain embodiments, the transition metal ions can be selected from the group consisting of cadmium, lead, zinc, or any combination thereof.

In some embodiments, the aqueous carbonate or bicarbonate solution comprises aqueous sodium bicarbonate.

In some embodiments, the soluble silicate product comprises a sodium silicate, such as sodium metasilicate (Na₂SiO₃).

In some embodiments, step (a) is performed at an elevated temperature and/or pressure, such as a temperature of from greater than room temperature (20° C.) (e.g., a temperature of from greater than 20° C. to 400° C.). In certain embodiments, step (a) is performed at a temperature of at least 100° C., such as a temperature of from 100° C. to 400° C., a temperature of from 100° C. to 300° C., a temperature of from 150° C. to 400° C., or a temperature of from 150° C. to 300° C.

In some embodiments, step (a) (the solution-based carbonation reaction) can comprise a reaction such as the following:

CaSiO₃(s)+Na₂CO₃(aq.)↔CaCO₃(s)+NazSiO₃(aq.)

In some embodiments, step (b) is performed at an elevated temperature and/or pressure, such as a temperature of from greater than room temperature (20° C.) (e.g., a temperature of from greater than 20° C. to 400° C.). In certain embodiments, step (b) is performed at a temperature of at least 50° C., such as a temperature of from 50° C. to 400° C., a temperature of from 50° C. to 300° C., a temperature of from 50° C. to 200° C., or a temperature of from 50° C. to 100° C.

In some embodiments, step (b) (the carbon dioxide capture reaction) can comprise a reaction such as the following:

Na₂SiO₃(aq.)+CO₂+H₂O↔Na₂CO₃(aq.)+H₂SiO₃(s).

In some embodiments, the carbon dioxide can comprise carbon dioxide gas. In certain embodiments, the carbon dioxide gas can comprise carbon dioxide present in air (e.g., the method can comprise direct air capture of carbon dioxide). In other embodiments, the carbon dioxide can comprise carbon dioxide emitted from a point source, such as an exhaust gas stream from an industrial process (e.g., flue gas).

In some embodiments, step (c) comprises heating the silicic acid to a temperature of at least 50° C., such as a temperature of at least 80° C., or a temperature of at least 100° C. In certain embodiments, step (c) comprises heating the silicic acid to a temperature of from 50° C. to 200° C., such as a temperature of from 50° C. to 150° C., a temperature of from 50° C. to 100° C., a temperature of from 50° C. to 150° C., a temperature of from 50° C. to 100° C., a temperature of from 100° C. to 200° C., a temperature of from 100° C. to 170° C., or a temperature of from 100° C. to 150° C.

Optionally, in some embodiments, the method further comprising reacting a silicate feedstock material with water vapor under conditions effective to generate hydrogen gas and the silicate precursor.

The silicate feedstock material can comprise any suitable silicate described below. In some embodiments, the silicate feedstock material comprises a silicate that comprises a reduced metal cation or metal (e.g., a transition metal or reduced transition metal cation such as Fe metal or an Fe²⁺ ion). In certain embodiments, the silicate feedstock material can comprise an industrial waste material that comprises a silicate (e.g., a magnesium and/or calcium silicate), such as fly ash, incinerated ash, slag, or any combination thereof.

In some embodiments, the reaction of the silicate feedstock material with water vapor is performed at an elevated temperature and/or pressure, such as a temperature of from 600° C. to 900° C.

In the methods and processes described herein can provide a process or method whereby a silicate (e.g., a calcium silicate) and carbon dioxide are reacted to produce a stable, aqueous insoluble carbonate (e.g., calcium carbonate) and silica. The processes and methods described herein can thus be used to capture carbon dioxide (a greenhouse gas) and react the carbon dioxide to generate a stable carbonate. This stable carbonate can serve as a carbon dioxide sink (sequestering the carbon dioxide and removing it from the atmosphere in a solid form). The resulting silica product generated by the processes and methods described herein can be of high purity, and can serve as an industrial feedstock for industries including the semiconductor and glass industries.

Depending upon the choice of feedstock, the methods and processes described herein can also utilize silicate industrial waste (e.g., steel slag, fly ash, etc.), producing valuable end products from these waste streams.

In some embodiments of the methods and processes described herein, the process can produce hydrogen (e.g., without attendant greenhouse gas emissions).

### Silicate Precursors and Silicate Feedstock Materials

The silicate precursor and/or silicate feedstock material can comprise any suitable silicate material. In some embodiments, the silicate precursor and/or silicate feedstock material can include a silicate that comprises at least one alkali earth metal, such as beryllium, magnesium, calcium, strontium, barium, radium, and combinations thereof. In certain embodiments, the silicate precursor and/or silicate feedstock material can comprise calcium. Optionally, the silicate precursor and/or silicate feedstock material can further comprise a non-alkali earth metal, such as aluminum, iron, titanium, manganese, potassium, sodium, or a combination thereof (optionally in addition to the alkali earth metal(s)).

In some embodiments, the silicate precursor and/or silicate feedstock material can comprise a silicates defined by the formula (Q)ₓ(M)_{y}SiO₃, where M represents an alkali earth metal (e.g., beryllium, magnesium, calcium, strontium, barium, radium, and combinations thereof), Q represents a non-alkali earth metal (aluminum, iron, titanium, manganese, potassium, sodium, or a combination thereof), y represents the number of different alkali earth metals and is ≤1 (i.e. 1, 2, 3, . . . ), and x represents the number of different non-alkali earth metals and is ≤0 (i.e. 0, 1, 2, . . . ).

In some embodiments, the silicate precursor and/or silicate feedstock material can comprise a silicate mineral. The silicate mineral can comprise a nesosilicate, a sorosilicate, an inosilicate (a single chain inosilicate or a double chain inosilicate), a cyclosilicate, a phyllosilicate, or a tectosilicate. Examples of silicate minerals include Chloritoid (Iron Magnesium Manganese Aluminum Silicate Hydroxide), Datolite (Calcium Boro-Silicate Hydroxide), Euclase (Beryllium Aluminum Silicate Hydroxide), Fosterite (Magnesium Silicate), Gadolinite (Yttrium Iron Beryllium Silicate), Andradite (Calcium Iron Silicate), Grossular (Calcium Aluminum Silicate), Pyrope (Magnesium Aluminum Silicate), Spessartine (Manganese Aluminum Silicate), Uvarovite (Calcium Chromium Silicate), Howlite (Calcium Boro-Silicate Hydroxide), Humite (Magnesium Iron Silicate Fluoride Hydroxide), Olivine (Magnesium Iron Silicate), Phenakite (Berylium Silicate), Sphene or Titanite (Calcium Titanium Silicate), Staurolite (Iron Magnesium Zinc Aluminum Silicate Hydroxide), Topaz (Aluminum Silicate Fluoride Hydroxide), Uranophane (Hydrated Calcium Uranyl Silicate), Bertrandite (Beryllium Silicate Hydroxide), Danburite (Calcium Boro-Silicate), Allanite (Yttrium Cerium Calcium Aluminum Iron Silicate Hydroxide), Clinozoisite (Calcium Aluminum Silicate Hydroxide), Epidote (Calcium Iron Aluminum Silicate Hydroxide), Zoisite (Calcium Aluminum Silicate Hydroxide), Ilvaite (Calcium Iron Silicate Hydroxide), Idocrase or Vesuvianite (Calcium Magnesium Aluminum Silicate Hydroxide), Okenite (Hydrated Calcium Silicate), Pectolite (Sodium Calcium Silicate Hydroxide), Aegirine (Sodium Iron Silicate), Augite (Calcium Sodium Magnesium Aluminum Iron Titanium Silicate), Diopside (Calcium Magnesium Silicate), Enstatite (Magnesium Silicate), Hedenbergite (Calcium Iron Silicate), Hypersthene (Magnesium Iron Silicate), Rhodonite (Manganese Iron Magnesium Calcium Silicate), Serandite (Sodium Manganese Calcium Silicate Hydroxide), Wollastonite (Calcium Silicate), Actinolite (Calcium Magnesium Iron Silicate Hydroxide), Anthophyllite (Magnesium Iron Silicate Hydroxide), Cummingtonite (Iron Magnesium Silicate Hydroxide), Edenite (Sodium Calcium Magnesium Iron Aluminum Silicate Hydroxide), Hornblende (Calcium Sodium Magnesium Iron Aluminum Silicate Hydroxide), Tremolite (Calcium Magnesium Iron Silicate Hydroxide), Babingtonite (Calcium Iron Manganese Silicate Hydroxide), Inesite (Hydrated Calcium Manganese Silicate Hydroxide), Axinite (Calcium Magnesium Iron Manganese Aluminum Borosilicate Hydroxide), Baratovite (Potassium Lithium Calcium Titanium Zirconium Silicate Fluoride), Benitoite (Barium Titanium Silicate), Beryl (Berylium Aluminum Silicate), Cordierite (Magnesium Aluminum Silicate), Eudialyte (Sodium Calcium Cesium Iron Manganese Zirconium Silicate Hydroxide Chloride), Milarite (Hydrated Potassium Calcium Aluminum Beryllium Silicate), Osumilite (Potassium Sodium Iron Magnesium Aluminum Silicate), Dravite (Sodium Magnesium Aluminum Boro-Silicate Hydroxide), Uvite (Calcium Sodium Iron Magnesium Aluminum Boro-Silicate Hydroxide), Apophyllite (Hydrated Potassium Sodium Calcium Silicate Hydroxide Fluoride), Cavansite (Hydrated Calcium Vanadium Silicate), Chlorite (Iron Magnesium Aluminum Silicate Hydroxide), Clinochlore (Iron Magnesium Aluminum Silicate Hydroxide), Talc (Magnesium Silicate Hydroxide), Gyrolite (Hydrated Calcium Silicate hydroxide), Biotite (Potassium Iron Magnesium Aluminum Silicate Hydroxide Fluoride), Phlogopite (Potassium Magnesium Aluminum Silicate Hydroxide Fluoride), Prehnite (Calcium Aluminum Silicate Hydroxide), Serpentine (Iron Magnesium Silicate Hydroxide), Albite (Sodium Aluminum Silicate), Andesine (Sodium Calcium Aluminum Silicate), Anorthite (Calcium Aluminum Silicate), Bytownite (Calcium Sodium Aluminum Silicate), Labradorite (Sodium Calcium Aluminum Silicate), Oligoclase (Sodium Calcium Silicate), Cancrinite (Sodium Calcium Aluminum Silicate Carbonate), Lazurite (Sodium Calcium Aluminum Silicate Sulfate Sulfide Chloride), The Quartz Group: (All Silicon Dioxide), Scapolite (Calcium Sodium Aluminum Silicate Chloride Carbonate Sulfate), Chabazite (Hydrated Calcium Aluminum Silicate), Harmotome (Hydrated Barium Potassium Aluminum Silicate), Heulandite (Hydrated Sodium Calcium Aluminum Silicate), Laumontite (Hydrated Calcium Aluminum Silicate), Mesolite (Hydrated Sodium Calcium Aluminum Silicate), Phillipsite (Hydrated Potassium Sodium Calcium Aluminum Silicate), Scolecite (Hydrated Calcium Aluminum Silicate), Stellerite (Hydrated Calcium Aluminum Silicate), Stilbite (Hydrated Sodium Calcium Aluminum Silicate), Xonotlite, and Thomsonite (Hydrated Sodium Calcium Aluminum Silicate).

In some embodiments, the silicate precursor and/or silicate feedstock material can comprise an inosilicate. Inosilicates, especially when comprising calcium, can be used as silicate precursors, although other metal silicates discussed herein can be viable alternatives. Examples of single chain calcium-containing inosilicates include Okenite (Hydrated Calcium Silicate), Pectolite (Sodium Calcium Silicate Hydroxide), Augite (Calcium Sodium Magnesium Aluminum Iron Titanium Silicate), Diopside (Calcium Magnesium Silicate), Hedenbergite (Calcium Iron Silicate), Rhodonite (Manganese Iron Magnesium Calcium Silicate), Serandite (Sodium Manganese Calcium Silicate Hydroxide) and Wollastonite (Calcium Silicate). In certain embodiments, the silicate precursor and/or silicate feedstock material can comprise a calcium silicate. As used herein, the term “calcium silicate” refers to naturally-occurring minerals or synthetic materials that are comprised of one or more of a group of calcium-silicon-containing compounds including CaSiO₃ (also known as “Wollastonite” or “pseudo-wollastonite” and sometimes formulated as CaO·SiO₂), Ca₃Si₂O₇ (also known as “Rankinite” and sometimes formulated as 3CaO·2SiO₂), Ca₂SiO₄ (also known as “Belite” and sometimes formulated as 2CaO·SiO₂), Ca₃SiO₅ (also known as “Alite” and sometimes formulated as 3CaO·SiO₂), Ca₅(SiO₄)₂CO₃ (also known as “Spurrite” and sometimes formulated as 2Ca₂SiO₄·CaCO₃), and Ca₆Si₆O₁₇(OH)₂ (also known as “Xonotlite”), each of which materials may include one or more other metal ions and oxides (e.g., aluminum, magnesium, iron or manganese oxides), or blends thereof, or may include an amount of magnesium silicate in naturally-occurring or synthetic form(s) ranging from trace amount (1%) to about 50% or more by weight.

In some embodiments, the calcium silicate can comprise a molar ratio of elemental Ca to elemental Si of at least about 0.50 (e.g., at least about 0.55, at least about 0.60, at least about 0.65, at least about 0.70, at least about 0.75, at least about 0.80, at least about 0.85, at least about 0.90, at least about 0.95, at least about 1.0, at least about 1.05, at least about 1.10, at least about 1.15, at least about 1.20, at least about 1.25, at least about 1.30, at least about 1.35, at least about 1.40, at least about 1.45, at least about 1.5, at least about 1.6, at least about 1.7, at least about 1.75, at least about 1.8, at least about 1.9, at least about 2.0, at least about 2.1, at least about 2.2, at least about 2.25, at least about 2.3, at least about 2.4, at least about 2.5, at least about 3, at least about 3.5, at least about 4, at least about 4.5, or at least about 5). In some embodiments, the calcium silicate can comprise a molar ratio of elemental Ca to elemental Si of about 5 or less (e.g., about 4.5 or less, about 4 or less, about 3.5 or less, about 3 or less, about 2.5 or less, about 2.4 or less, about 2.3 or less, about 2.5 or less, about 2.2 or less, about 2.1 or less, about 2.0 or less, about 1.9 or less, about 1.8 or less, about 1.75 or less, about 1.7 or less, about 1.6 or less, about 1.5 or less, about 1.45 or less, about 1.40 or less, about 1.35 or less, about 1.30 or less, about 1.25 or less, about 1.20 or less, about 1.15 or less, about 1.10 or less, about 1.05 or less, about 1.00 or less, about 0.95 or less, about 0.90 or less, about 0.85 or less, about 0.80 or less, about 0.75 or less, about 0.70 or less, about 0.65 or less, about 0.60 or less, or about 0.55 or less).

The calcium silicate can comprise a molar ratio of elemental Ca to elemental Si ranging from any of the minimum values described above to any of the maximum values described above. For example, in some embodiments, the calcium silicate precursor can comprise a molar ratio of elemental Ca to elemental Si of from about 0.50 to about 5 (e.g., from about 1.0 to about 5, or from about 1.0 to about 3.5).

In certain embodiments, the silicate precursor and/or silicate feedstock material can comprise “wollastonite” or “pseudo-wollastonite” and their derivatives. U.S. Pat. No. 6,433,049 further discusses wollastonite and is hereby incorporated by reference.

The wollastonite or pseudowollastonite can be natural or synthetic. In some embodiments, the wollastonite or pseudowollastonite can comprise synthetic pseudowollastonite. Synthetic pseudowollastonites can be made by a variety of methods. For example, in one embodiment, the silicate precursor can comprise a synthetic pseudowollastonite formed by mixing limestone and fumed silica and calcining the mixture. In another example, the silicate precursor can comprise synthetic pseudowollastonite formed by reacting a calcia-rich calcium silicate, such as rankinite (3CaO·2SiO₂), hatruite (3CaO·SiO₂), or a combination thereof with silica. In another example, the silicate precursor can comprise synthetic pseudowollastonite formed by reacting an industrial waste material, such as coal ash, slags from iron processing, or a combination thereof to form the synthetic pseudowollastonite. In embodiments where a synthetic pseudowollastonite is used, methods can optionally further comprise synthesizing the pseudowollastonite.

In some embodiments, the silicate precursor and/or silicate feedstock material comprises an industrial waste material that comprises a silicate (e.g., a magnesium and/or calcium silicate), such as fly ash, incinerated ash, slag, or any combination thereof.

The term “fly ash” is used herein generally to refer to ash by-products of the combustion of pulverized coal (e.g., in electrical power generation plants). The term fly ash, as used herein, can thus include flue-ash (i.e., fine ash particles generated during the combustion of coal that rise with flue gases, and are captured with particle filtration equipment before the exiting the chimney of a coal-fired power plant), bottom ash (e.g., ash produced during the combustion of coal which does not rise with flue gases), as well as a combination thereof (i.e., coal ash).

Fly ash is formed of mineral matter that is typically of very fine particle size, ranging from less than 1 micron to over 100 microns in some cases. The fly ash particles possess a substantially spherical shape as a consequence of the high temperature melting and coalescence in the furnace of the mineral matter accompanying the coal.

Mineralogically, fly ash is predominantly amorphous, or non-crystalline, in nature as a result of the rapid quenching of clay/shale minerals as they rapidly pass through the boiler flame and dust collection system of the power plant. For some fly ashes, the amorphous material can be described as an aluminosilicate glass similar in composition to the mineral mullite (Al₆Si₂O₁₃); for other fly ashes, it can be described as a calcium aluminosilicate glass similar in composition to the mineral anorthite (CaAl₂Si₂O₈). Fly ashes can also contain smaller amounts of a variety of other mineral components derived from thermal modification of accessory minerals present in the coal. These can include mullite, quartz (SiO₂), ferrite spinel (Fe₃O₄), hematite (Fe₂O₃), dicalcium silicate (Ca₂SiO₄), tricalcium aluminate (Ca₃Al₂O₆), and lime (CaO). These mineral components can occur as inclusions in the glass particles and/or as discrete particles.

It is commonly known that the chemical composition of fly ash changes as a result of the type of coal being burned in the boiler. These differences are largely in the relative proportions of the element calcium present in the ash. For example, high rank bituminous coals generally have a low calcium content and produce an ash with relatively low calcium, typically less than 5% CaO; whereas low rank thermal coals generally have much higher content of calcium, typically in the range 8-20% CaO for lignite coals and 20-30% CaO, or higher, for subbituminous coals. These differences are recognized by ASTM specifications, such as ASTM C-618, and by Canadian specifications that classify the ashes based on their CaO content.

Current ASTM C-618 (Coal Fly Ash or Calcined Natural Pozzolan for Use in Concrete) specifications include only two designations or classes of fly ash: “Class F” and “Class C” fly ashes. The “Class F” designation generally incorporates fly ashes originating from the combustion of bituminous and lignite coals and the “Class C” designation generally incorporates ashes from the combustion of subbituminous coals. These designations are based on the chemical composition of the fly ash in such a way that when the sum of the element oxides (SiO₂+Al₂O₃+Fe₂O₃) derived from chemical analysis of the ash is equal to or greater than 70% by weight, then the fly ash is designated a “Class F” fly ash. When the sum of the element oxides is equal to or greater than 50% by weight, the fly ash is designated as a “Class C” fly ash. In Canada, as mentioned above, fly ashes have certain designations based on their CaO content. In particular, a fly ash is considered a “Class F” when it includes less than 8% CaO, a “Class CI” when it includes 8-20% CaO, and a “Class CH” when it includes greater than 20% CaO.

The fly ash can be a lignite fly ash, a subbituminous fly ash, a bituminous fly ash, or a blend of two or more fly ashes (e.g., a subbituminous/bituminous fly ash blend). The fly ash can be a Class C fly ash, a Class F fly ash, or a blend thereof.

The term “slag” as used herein can include any welding or furnace slag, in particular furnace slag from metal production or processing. In some examples, the slag can be a blast furnace (BF) slag, an air-cooled blast furnace (ACBF) slag, a granulating blast furnace (GBF) slag, a basic oxygen furnace (BOF) slag, a ladle furnace basic slag (LS) or an electric arc furnace (EAF) slag. In certain embodiments, the slag can comprise a blast furnace (BF) slag, an air-cooled blast furnace (ACBF) slag, a granulating blast furnace (GBF) slag, a basic oxygen furnace (BOF) slag, a ladle furnace basic slag (LS) or an electric arc furnace (EAF) slag from ferrous metal production, non-ferrous metal production, or phosphorus production. In certain embodiments, the slag can comprise a blast furnace (BF) slag, an air-cooled blast furnace (ACBF) slag, a granulating blast furnace (GBF) slag, a basic oxygen furnace (BOF) slag, a ladle furnace basic slag (LS) or an electric arc furnace (EAF) slag from iron or steel production.

### Examples

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Materials and Methods

Steel Slag Preparation. BOF steel slag samples were collected from Cleveland Cliffs-Cleveland Works. Four different types of slag were obtained: skimmed, recycled endpoint, mixed fines, and aged fines. The skimmed slag was scooped directly from the BOF before slagging off. The recycled endpoint slag is typically reused in the blast furnace. The mixed fines consisted of unrecyclable slag waste generated in the BOF, while the aged fines were similar but had been exposed to outdoor conditions for an unspecified period. The Cleveland Cliffs-Cleveland Works BOF steel slag processing flow chart, with endpoints for the four types of slag analyzed, is shown in FIG. 7.

To prepare the slag for testing, large chunks were first crushed to approximately 0.5 cm using a sledgehammer. Then, 70 g of slag was loaded into a 75 mL alumina jar with a stainless-steel jacket under an argon atmosphere to prevent unwanted reactions with air during milling. The slag was milled for 30 minutes in an Across International Desktop High Energy Vibratory Ball Mill, rested for 20 minutes, and milled for another 30 minutes. The resulting powder was scraped out using a metal spatula and sifted through a 60-mesh (250-micron) sieve. Material that did not pass through was first processed with a 2 mm sieve, and any remaining oversized particles were reloaded into the alumina jar for additional milling, with fresh slag supplemented to reach 70 g. The final steel slag powder was stored in a glovebox under argon before experiments.

Hydrogen Production Performance Testing. Hydrogen production experiments were conducted in a custom quartz tube with an outer diameter of 25 mm, a length of 609.6 mm, and a 3 mm thick G0 (160-250 micron) quartz frit positioned 15 mm off-center. A 6 g sample of steel slag was packed between layers of quartz wool, which rested on the frit at the center of the tube. The tube was then loaded into a vertically oriented 1100° C. split-tube furnace (Thermcraft Protégé XST). A gas mixture of 100 sccm containing 2% water vapor diluted in argon flowed through the packed sample bed. The furnace was heated to 600° C. at a ramp rate of 10° C./min and held at this temperature for 8 hours for steam to H₂ conversion.

Hydrogen production was monitored using a gas chromatograph (Inficon Micro GC Fusion), with indicating Drierite used to remove any unreacted water vapor before analysis to protect the GC. To ensure consistent data collection, the gas chromatograph was started when the furnace setpoint reached 100° C. After the experiment, the processed steel slag was returned to the argon glove box for storage.

CO₂ Capture Performance Testing. CO₂ capture experiments were conducted using a series of two 250 mL gas washing bottles, each placed on a separate hotplate with a stir bar and wrapped in insulation. Unless otherwise noted, experiments were performed on steam reacted steel slag for both point-source and direct air capture (DAC) scenarios.

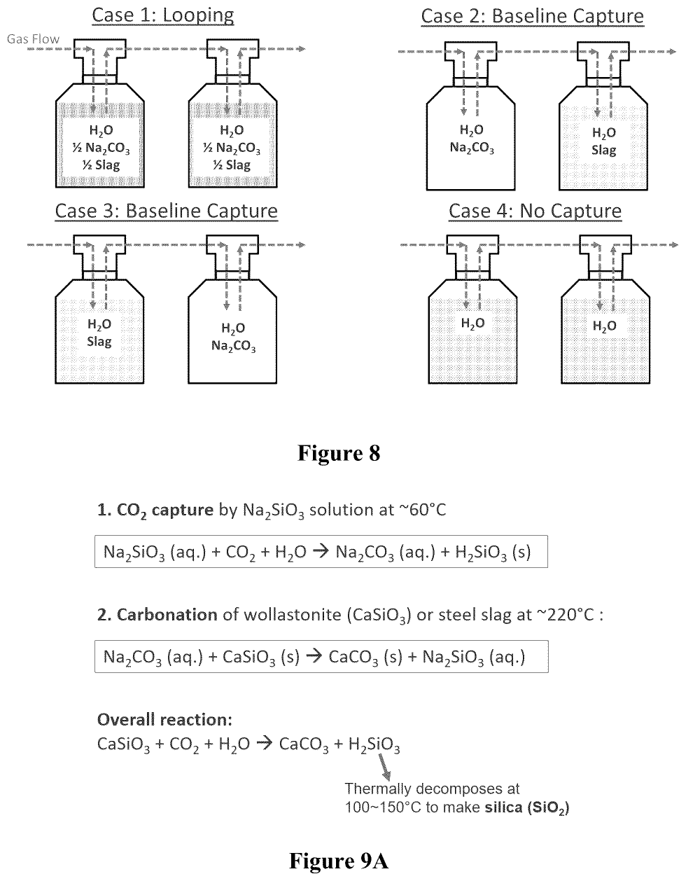

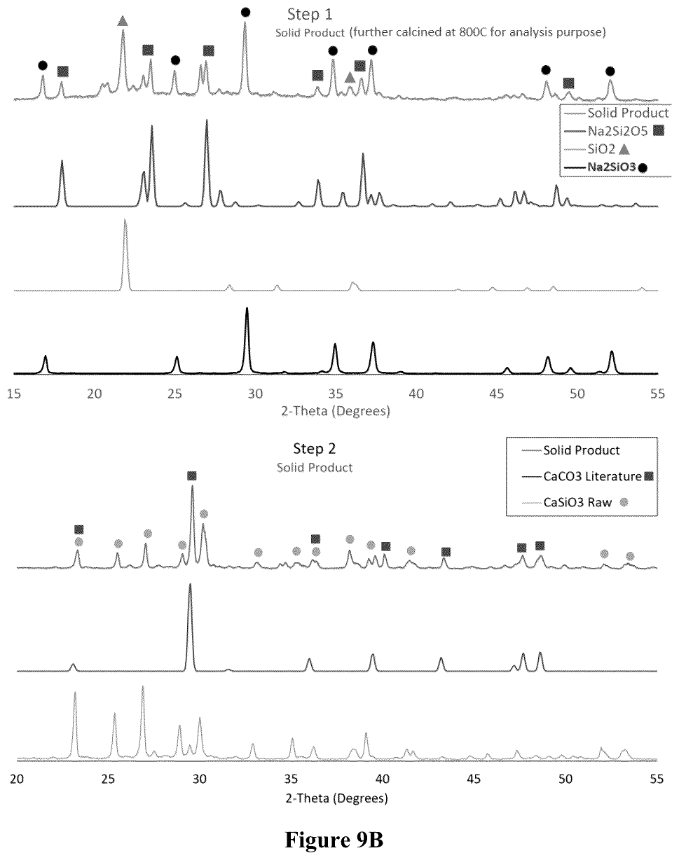

Four experimental cases were tested: looping, two baselines, and a blank run (FIG. 8). Each gas washing bottle was filled with 60 mL of deionized (DI) water. For looping experiments, 0.625 g of Na₂CO₃ (Sigma-Aldrich) and 0.25 g of steel slag were added to each bottle. The bottle caps were secured, and dip tubes were placed halfway into the solution. Gas lines were connected using a two-way valve at the inlet of the first bottle and the outlet of the second. The system was flushed with argon before sealing. The bottles were then heated to the reaction temperature (24° C. or 45° C.) at 80 rpm for 45 minutes—this step is referred to as the carbonation reaction. For 45° C. the hotplates were set to 60° C.

After carbonation, pH and temperature were recorded using an Ohaus Starter 2200 pH Bench Meter (ST322 electrode) and a K-type thermocouple. The bottles were then flushed with 90 sccm argon for 5 minutes before initiating the CO₂ capture step. The CO₂ concentration was monitored during the flush to be on average less than 0.01%. The CO₂ capture step is where 90 sccm of either 4% or 20% CO₂/Ar was bubbled through the solution for 15 minutes, followed by 20 minutes of pure argon flow that gradually decreases the CO₂ concentration due to the empty space in the wash bottle. CO₂ concentration in the outlet gas was quantified using the gas chromatograph, with indicating Drierite used to remove any residual water vapor. To ensure consistent data collection, the gas chromatograph was started 1 minute before the CO₂ flow began.

One cycle consisted of both the carbonation and CO₂ capture steps. After each cycle, 0.25 g of steel slag was added to each bottle, and the process was repeated for 5 or 10 cycles. The baseline experiments followed the same procedure but with different initial reactant distributions so that slag-water mixture did not interact with Na₂CO₃. Baseline 1 had 0.5 g of steel slag in the first bottle and 1.25 g of Na₂CO₃ in the second. Baseline 2 had 1.25 g of Na₂CO₃ in the first bottle and 0.5 g of steel slag in the second. Each wash bottle in the baseline cases also included 60 mL DI water. CO₂ capture efficiency in looping and baseline experiments was calculated relative to a blank run, where CO₂ was bubbled through only water to characterize the supply gas CO₂ profile along time.

DAC experiments followed the same procedure, with each gas washing bottle containing 30 mL of DI water. The looping experiments used 0.0625 g of Na₂CO₃ and 0.025 g of steel slag per bottle, while the baselines contained either 0.125 g of Na₂CO₃ in one bottle and 0.05 g of steel slag in the other. The blank run contained only DI water. For DAC, 90 sccm of air (from a compressed cylinder containing 343 ppm CO₂) was flowed for 15 minutes, followed by 20 minutes of argon flow, the same schedule as the 4% CO₂ capture. For the 5-minute flush after carbonation, the CO₂ concentration was monitored to be on average less than 0.002%.

Material Characterization Using XANES. X-ray absorption near edge structure (XANES) was conducted by easy XAFS300+ to measure the oxidation state of iron (Fe) in steel slag before and after the reaction with steam. The X-ray source was set at 36 kV and 20 mA to acquire energy absorption spectra ranging from 7000 eV to 7600 eV for Fe K edge. Steel slag and standard materials (Fe, FeO, Fe₃O₄, and CoFe₂O₄) were protected against air oxidation using Kapton tape. XANES data was analyzed by Athena software to give normalized absorption (u) vs. absorption energy.

Material Characterization Using TGA. Experiments were conducted using a Themys Thermogravimetric Analyzer (TGA). For quantifying the CO₂ release from carbonated slag and from Na₂CO₃/NaHCO₃ solution, 0.1 g of solid or 1 mL of solution was placed in a 1300 mm³ alumina crucible. Argon (50 sccm) flowed over the sample, and the product gas was analyzed using a gas chromatograph, with indicating Drierite used to remove any residual water vapor. For 4% CO₂ capture slag and solution, the temperature profile consisted of: 35 minutes at 20° C., 120 minutes at 95° C., and 60 minutes at 800° C. For DAC slag, the same temperature profile was used, except the dwell time at 95° C. was reduced to 30 minutes. The ramp and cooling rates were 5° C./min and 10° C./min, respectively.

Material Characterization using XRD. X-ray diffraction (XRD) was performed using a Rigaku SmartLab X-ray diffractometer with Cu Kα radiation (λ=1.5406 Å) at 40 kV and 44 mA under ambient pressure and temperature. The Bragg-Brentano focusing method was used, and a diffracted beam monochromator was employed to reduce iron fluorescence. Steel slag data was collected over a 20 range of 20° to 70° with a step size of 0.02° and a scan speed of 2.3°/min. SiO₂ data was collected using the same procedure with a 20 range of 20° to 70°. Samples were finely ground in a mortar and pestle and mounted on a glass holder. Phase identification was performed using PDXL software with PDF2 2023 database.

Material Characterization using UV-VIS and ICP-OES. Ca and Si concentrations were measured by Inductively Coupled Plasma Optical Emission Spectrometry (ICP-OES) and Ultraviolet-Visible Spectroscopy (UV-VIS), respectively. Ca concentrations were determined using a PerkinElmer Optima 3000DV ICP-OES system, while Si concentrations were measured using a LabTech UV 8100-Series spectrophotometer with the silicon-molybdenum yellow spectrophotometric method.

For sample preparation, 120 mL of DI water was added to a beaker, which was then placed on a hotplate to maintain a constant solution temperature of 25° C., 45° C., or 65° C. with stirring at 80 rpm. After reaching the set temperature, 0.5 g of slag was added to the water, and samples were drawn at regular intervals. After 150 minutes, 1.25 g of Na₂CO₃ was introduced, and sampling continued at regular intervals.

Material Characterization using SEM/EDS. Scanning Electron Microscopy (SEM) was performed using a Thermo Fisher Scientific Apreo Scanning Electron Microscope. Imaging was conducted in secondary electron (SE) mode with an Everhart-Thornley Detector (ETD) at 5 kV and 0.8 nA. Energy-dispersive X-ray spectroscopy (EDS) was performed using the same microscope at 10 kV and 6.4 nA, equipped with an EDAX Octane Elect 30 mm² silicon drift detector (SDD).

Samples were dispersed in DI water and sonicated at 25° C. for 5 minutes. 10 μL of the dispersion was pipetted onto an SEM stub and dried on a hotplate at 80° C. for 5 hours. Steel slag samples were directly dropped on aluminum SEM stubs, while a layer of carbon tape was used for precipitated SiO₂ samples.

### Results and Discussion

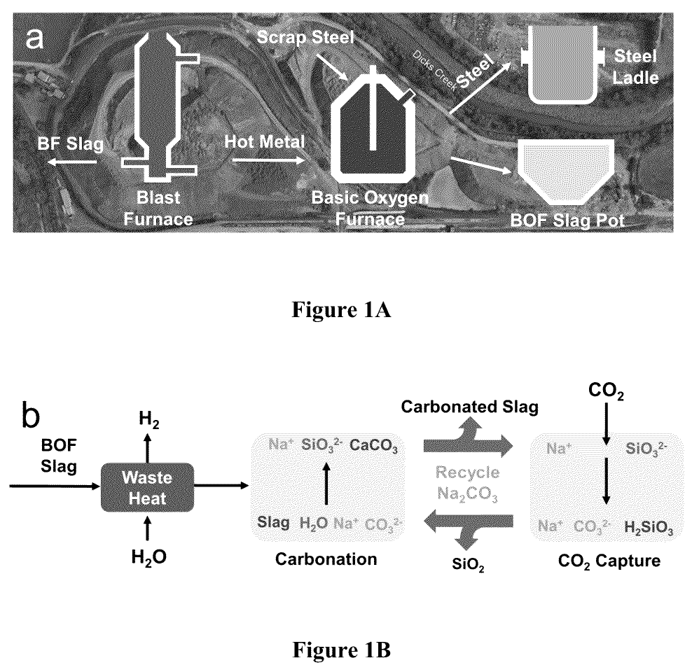

Process Description. The process evaluated in these examples can include (1) steam to H₂ conversion and (2) sodium carbonate looping for CO₂ mineralization (FIG. 1B). Basic Oxygen Furnace (BOF) steel slag is mainly composed of calcium silicates, calcium iron (III) oxide, and magnesium iron (II) oxide. In Step 1 (H₂ production), water vapor was exothermically reacted with the Fe²⁺ in steel slag to produce H₂ (Equation 1). Additionally, the steam treatment helped make the slag brittle and porous compared to traditionally air-cooled slags, so that the slag milling becomes much less energy intensive. While utilized in this example, the H₂ production reaction (referred to herein as “steam treatment”) is not required prior to the subsequent sodium carbonate looping for reactive CO₂ capture.

$$3 FeO ( s ) + {H}_{2} O ( g ) \to {Fe}_{3} {O}_{4} ( s ) + {H}_{2} ( g ) ; \qquad ( Eq . 1 )$$

$$Δ H ( 600 ° C . ) = - 52.76 kJ / mol$$

Step 2 (carbonation) was an exothermic reaction that carbonated the major slag component, calcium silicates, using a Na₂CO₃ solution at 20˜70° C. and 1 atm, producing sodium silicate (noted as Na₂SiO₃) solution and CaCO₃ precipitate to permanently store CO₂ (Equation 2). Formula “CaSiO₃” was used because ICP-OES analysis showed a Ca:Si molar ratio of 1. The Na₂SiO₃ solution was then filtered away from the solid mixture of CaCO₃ and unreactive slag components (together noted as carbonated slag).

$${Na}_{2} {CO}_{3} ( aq ) + {CaSiO}_{3} ( s ) \to {Na}_{2} {SiO}_{3} ( aq ) + {CaCO}_{3} ( s ) ; \qquad ( Eq . 2 )$$

$$Δ H ( 45 ° C . ) = - 83.44 kJ / mol$$

Step 3 (CO₂ capture) is an exothermic reaction that utilizes the highly alkaline Na₂SiO₃ solution from Step 2 to absorb CO₂ and form silicic acid (noted as H₂SiO₃) precipitate; meanwhile, the Na₂CO₃ consumed in Step 2 is regenerated (Equation 3).

$${CO}_{2} ( g ) + {Na}_{2} {SiO}_{3} ( a q ) + {H}_{2} O ( l ) \to {H}_{2} {SiO}_{3} ( s ) + N {a}_{2} {CO}_{3} ( aq ) ; \qquad ( Eq . 3 )$$

$$Δ H ( 45 ° C . ) = - 21.4 kJ / mol$$

The H₂SiO₃ precipitate was then filtered for Step 4 to decompose it into silica (SiO₂) and water vapor (Equation 4). This regenerated the water consumed in Step 3. A small amount of <˜ 100° C. heat was sufficient for the decomposition. Suitable heat can be provided by the waste heat of slag.

$${H}_{2} {SiO}_{3} ( s ) \to {SiO}_{2} ( s ) + {H}_{2} O ( g ) ; \qquad ( Eq . 4 )$$

$$Δ H ( 100 ° C . ) = 36.43 kJ / mol$$

At this point, additional steel slag could be added, and the cycle could continue. The overall reaction of Na₂CO₃ looping, namely reactions (2) through (4), was thus:

$${CO}_{2} ( g ) + {CaSiO}_{3} ( s ) = {SiO}_{2} ( s ) + {CaCO}_{3} ( s )$$

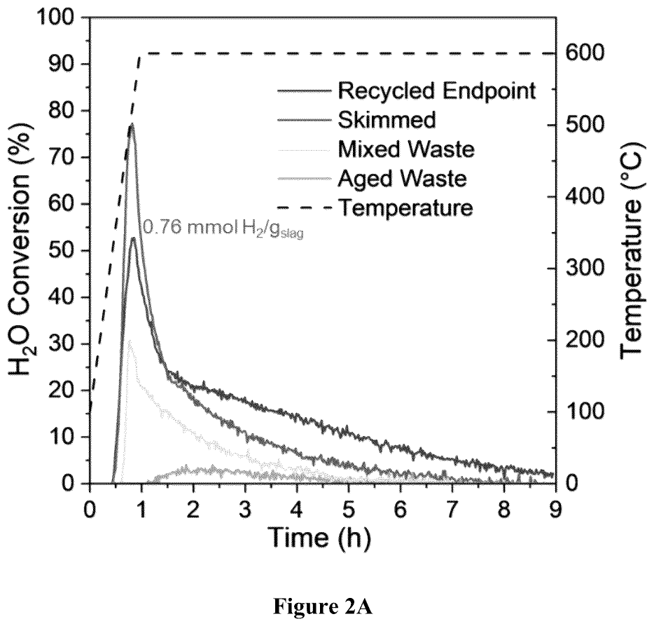

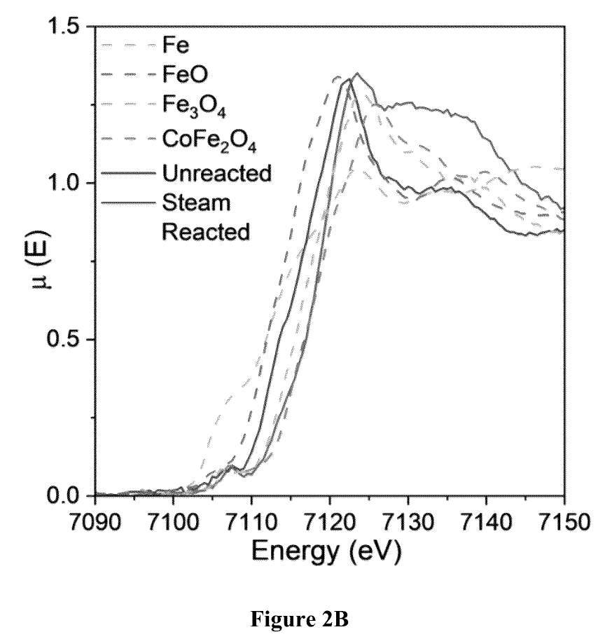

Hydrogen Production. In Step 1, hydrogen (H₂) was produced by reacting steam with BOF steel slags. Experiments were conducted using 6 grams of steel slag at 600° C., with a mixture of 2 sccm H₂O and 98 sccm Argon (Ar). The H₂ produced by different steel slags is shown in FIG. 2A through water conversion. The recycled endpoint slag produced the most hydrogen, yielding 1.02 mmol H₂ per gram of steel slag, followed by skimmed slag with 0.76 mmol H₂ per gram. Mixed fines and aged fines produced less hydrogen, with 0.34 and 0.07 mmol H₂ per gram of steel slag, respectively.

The varying amounts of H₂ produced from different BOF slags highlight the importance of slag handling in the process. Different batches of steel slag can inherently contain more reduced iron (Fe²⁺) species, leading to higher H₂ production. However, slag handling also plays a significant role. Skimmed slag, scooped out of the BOF and cooled in large chunks (approximately 0.15 m), and recycled endpoint slag, separated into chunks larger than ⅜″, have less surface area for the reduced iron to react with air or water during the cooling and storage processes. This results in higher H₂ production compared to smaller chunks like mixed fines, which have a higher surface area for iron oxidation. Aged fines, having more time to react with atmospheric oxygen and water, produce even less hydrogen.

For practical implementation, the hydrogen production step should occur soon after the slag leaves the BOF furnace to leverage the slag waste heat and minimize the oxidation of reduced iron.

To determine the oxidation state of iron, X-ray Absorption Near Edge Structure (XANES) analysis was conducted on unreacted and steam-reacted skimmed slag (FIG. 2B). The unreacted skimmed slag had an oxidation state close to that of reference material FeO. As expected, the oxidation state of iron in the steam-reacted slag increased, resembling that of CoFe₂O₄ and Fe₃O₄.

CO₂ Capture Performance. Steps 2 and 3 involved the aqueous carbonation of steel slag using Na₂CO₃, followed by CO₂ capture. Ten Na₂CO₃ looping cycles of point source CO₂ capture and DAC (direct air capture) with skimmed BOF slag were conducted at 45° C. Each cycle included 45 minutes of carbonation, followed by 15 minutes of dilute CO₂ flow and 20 minutes of pure argon.

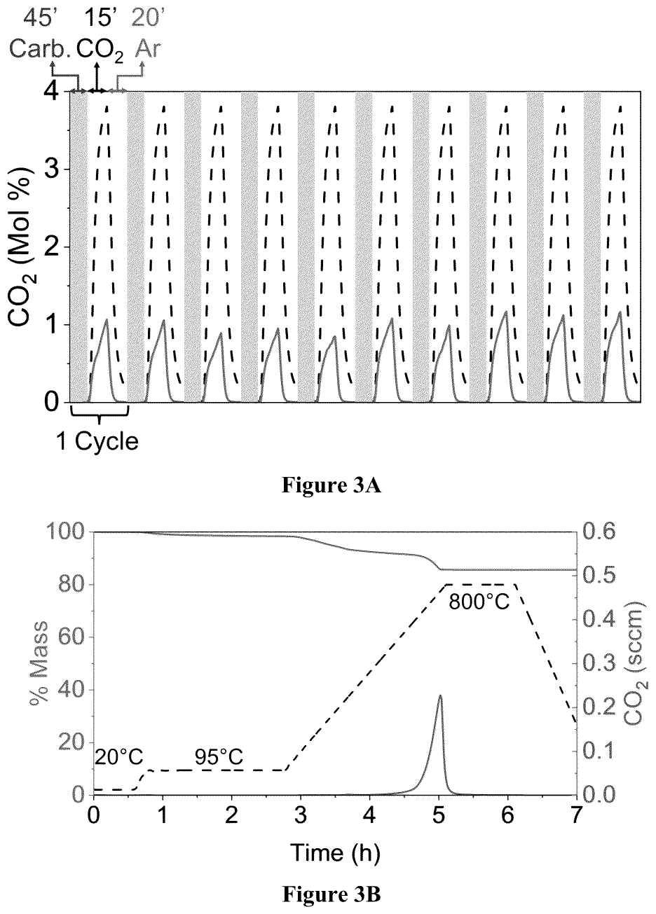

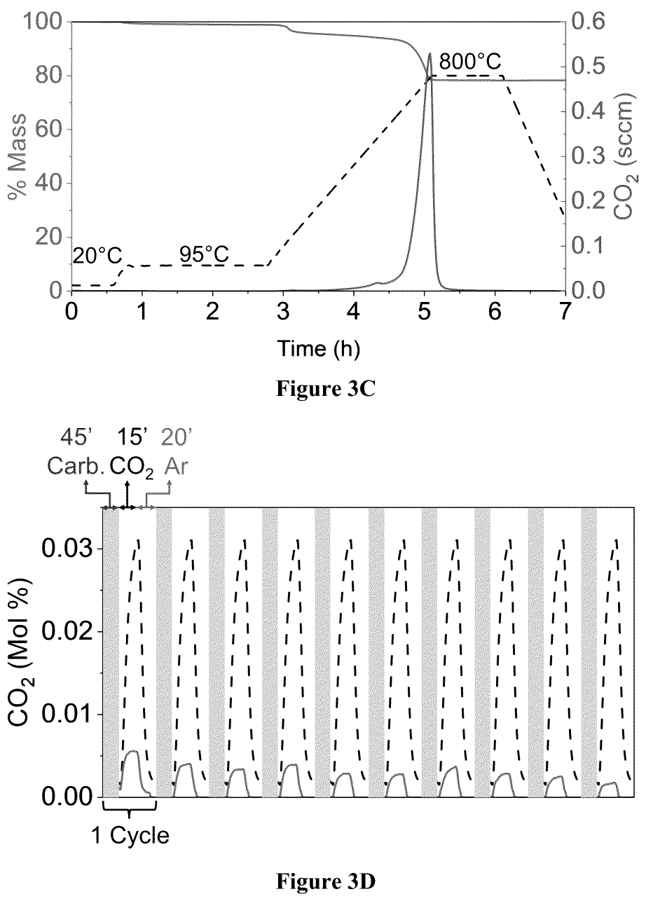

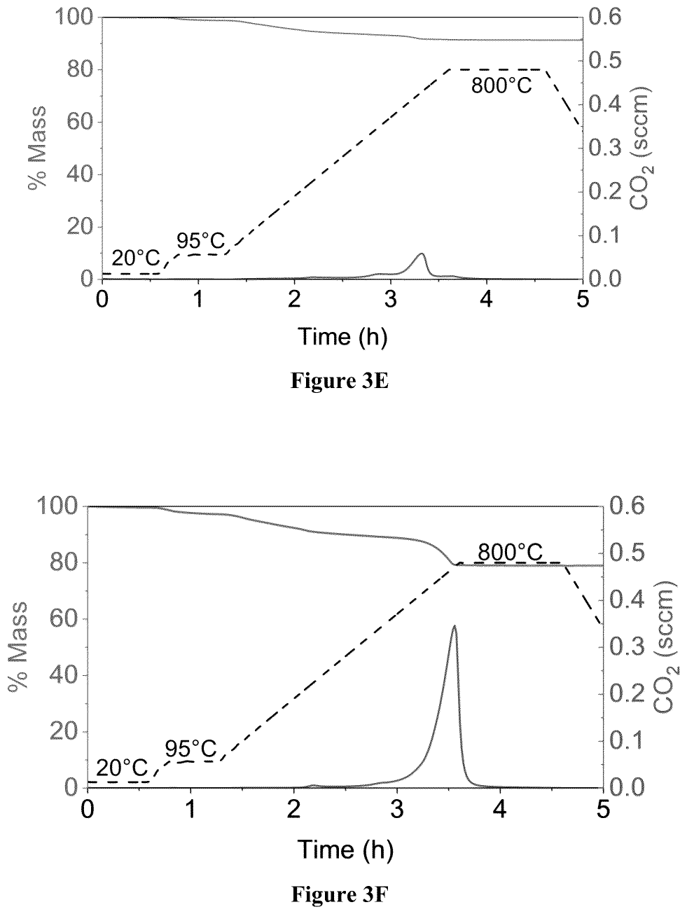

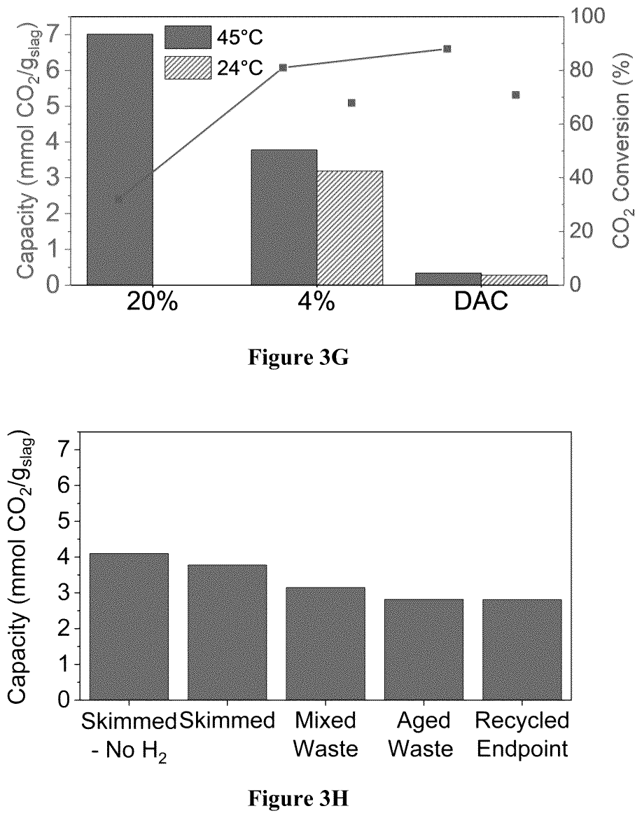

Point Source Capture. For point source capture, 0.5 g of steel slag was processed each cycle with 90 sccm of 4% CO₂/Ar. The CO₂ capture performance over the 10 Na₂CO₃ looping cycles is depicted in FIG. 3A, compared to a blank run. The blank run was conducted to measure the supplied CO₂ concentration profile. The cycles showed stability over 10 cycles with an average of 79% CO₂ conversion. Given the large CO₂ conversion and gas profiles, it is evident that the solution can still capture additional CO₂ in each cycle if given additional reaction time. However, the advantage of reduced cycle time and increased slag processing rate is important for industrial applications.

We here define “mineralize” as CO₂ being turned into a stable carbonate form that would not release CO₂ unless heated above 400° C., such as CaCO₃. In comparison, we define “capture” to include both the mineralized CO₂ and CO₂ converted to a less stable form, such as being captured by Na₂CO₃ to become NaHCO₃. Thermogravimetric analysis (TGA) and CO₂ evolution were performed to evaluate the amount of CO₂ mineralized in the carbonated slag. FIG. 3B shows the TGA and CO₂ evolution from a baseline experiment with slag and Na₂CO₃ separately capturing CO₂. The material mass drop and CO₂ evolution peak at 800° C. are due to the decomposition of calcium carbonate (CaCO₃) within carbonated slag into CO₂ and CaO. In comparison, FIG. 3C shows the TGA and CO₂ evolution from carbonated slag from Na₂CO₃ looping cycles.

The looping mineralizes 1.9 times the amount of CO₂ as the baseline. The difference in mineralization can be explained as follows. The looping mineralizes CO₂ via the reaction between Na₂CO₃ and steel slag, while the baseline mineralizes CO₂ via the reaction between CO₂ and steel slag. A 50 times larger molar solubility of Na₂CO₃ than CO₂ in water contributes to faster reaction kinetics. Beyond the difference in mineralization capacity between looping and baseline, part of the captured CO₂ in the baseline experiment is by Na₂CO₃ and becomes NaHCO₃ in the solution phase. Therefore, the CO₂ capture capacity of looping is only 1.63 times that of baseline.

Direct Air Capture. For DAC, 0.05 g of steel slag was processed each cycle with 90 sccm of 343 ppm CO₂ (from a compressed air cylinder). The performance of the 10 Na₂CO₃ looping cycles for DAC is depicted in FIG. 3D, compared to the blank run. Over 10 cycles, the CO₂ capture performance increases due to the capture capacity of the slag from previous cycle(s) not being fully utilized. The average CO₂ conversion over 10 cycles is 90%. TGA and CO₂ evolution results comparing the CO₂ mineralized in a DAC baseline (FIG. 3E) with the Na₂CO₃ looping (FIG. 3F) shows 5.2 times higher CO₂ mineralization in looping than baseline.

Effects of Reaction Conditions and Slag Types. The CO₂ capture performance for skimmed slag was compared over 5 cycles among 20%, 4%, and 343 ppm CO₂ (DAC) at 45° C. and room temperature (24° C.) (FIG. 3G). The 20% CO₂ is a special case for capturing the percentage of CO₂ in the flue gas of a BOF steel plant at Cleveland Cliffs-Cleveland Works. The CO₂ capture capacity decreases with the concentration of CO₂ in the gas; however, the conversion increases. The difference in CO₂ capture capacity between 45° C. and room temperature is only 1.21 times for DAC and 1.18 times for point source, highlighting the high kinetics at mild temperature of the solution-based CO₂ capture.

The CO₂ capture capacity of different BOF slags for 4% CO₂ at 45° C. was compared over 5 cycles. “Skimmed—No H₂” refers to skimmed slag that did not react with water for H₂ production prior to Na₂CO₃ looping. The skimmed slag with no H₂ production captured the most CO₂, with 4.1 mmol CO₂ per g steel slag, followed by steam-reacted skimmed slag with 3.78 mmol CO₂ per g steel slag. The mixed waste, aged waste, and recycled endpoint followed with 3.15, 2.82, and 2.81 mmol CO₂ per g steel slag, respectively.

We propose several potential reasons why the skimmed slag with no H₂ production captured more CO₂ than the skimmed slag that had converted steam to H₂. First, CaO in the slag can react with steam at high temperature to form calcium hydroxide, which can then react with CO₂ in the air between experiments/transporting to the glovebox, lowering the CO₂ capture capacity later on. Secondly, when the steel slag is reacted with steam, the iron oxide gains oxygen, increasing the total mass of the slag. Therefore, one gram of slag after reacting with steam will have less calcium silicate in comparison. The skimmed steel slag captured more CO₂ because the main calcium silicate form is Ca₃SiO₅, which has been shown to have higher reactivity than Ca₂SiO₄ and CaSiO₃. The remaining steel slags were all mainly composed of Ca₂SiO₄.

Unlike H₂ production, the handling of steel slag and aging did not significantly affect the amount of CO₂ captured, which was mainly due to the calcium silicate composition and the amount of CaO in the slags.

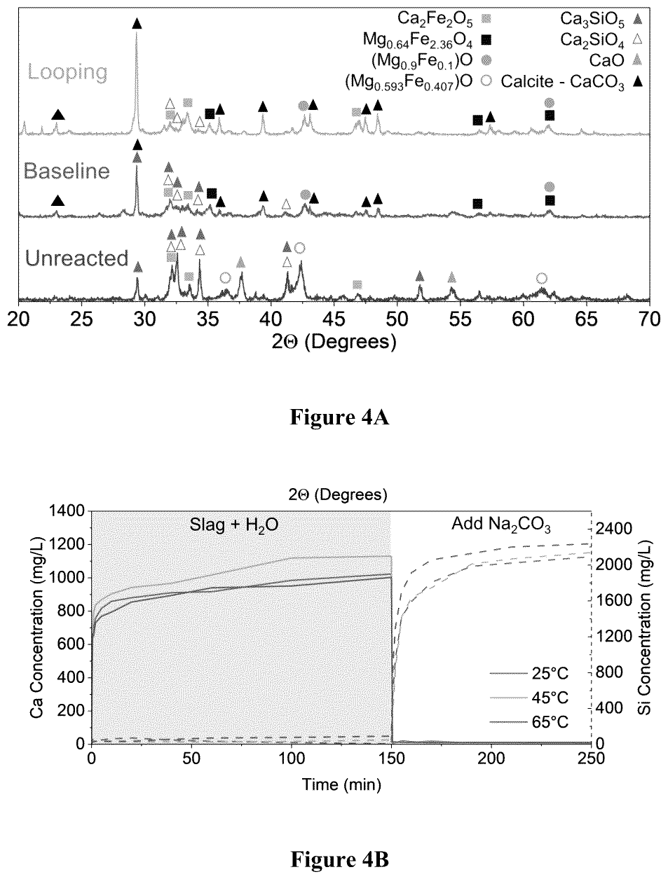

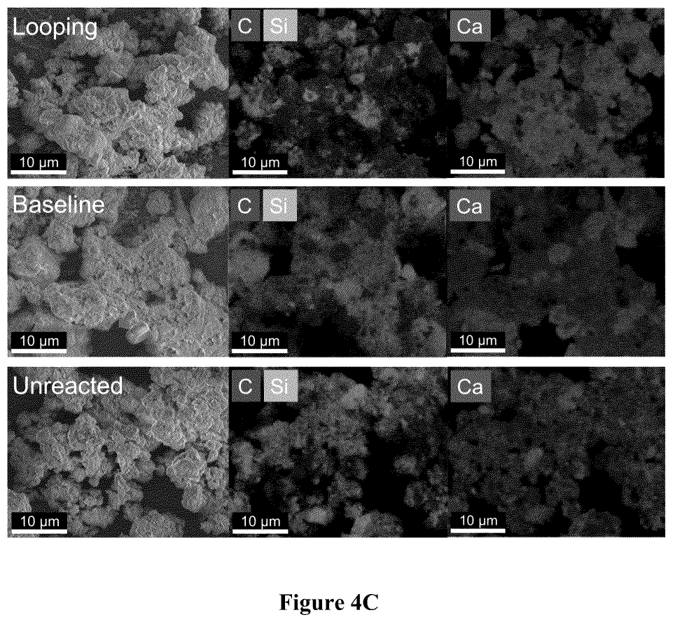

Material Characterization and Process Verification. XRD was used to compare unreacted skimmed BOF slag with slags after 10 baseline cycles and after 10 Na₂CO₃ looping cycles capturing 4% CO₂ at 45° C. (FIG. 4A). The unreacted skimmed slag was mainly composed of Ca₂Fe₂O₅, Ca₃SiO₅, Ca₂SiO₄, CaO, and (Mg_{0.593}Fe_{0.407})O. The Ca₂Fe₂O₅ is an unreactive phase. In both the baseline and looping methods, (Mg_{0.593}Fe_{0.407})O was oxidized to Mg_{0.64}Fe_{2.36}O₄ by reacting with steam, leaving Mg_{0.9}Fe_{0.1}O. The presence of Mg_{0.64}Fe_{2.36}O₄ is consistent with the similarity of the oxidation state of skimmed slag after reacting with steam to CoFe₂O₄ and Fe₃O₄ in FIG. 2B. The Na₂CO₃ looping method showed higher conversions of Ca₂SiO₄, Ca₃SiO₅, and CaO to CaCO₃ after CO₂ capture compared to the baseline method. This is evident from the difference in relative height for the main CaCO₃ peak around 20 of 29°. These results qualitatively confirm the findings of the TGA experiments and CO₂ evolutions discussed in the previous sections.

Calcium (Ca) and silicon (Si) concentrations were measured by ICP-OES and UV-VIS, respectively (FIG. 4B). Ca and Si concentration evolutions were measured in an aqueous solution during the dissolution of skimmed slag in water for 150 minutes, followed by the addition of Na₂CO₃. The dissolution of skimmed steel slag in water results in the release of Ca into the solution from phases such as Ca-silicates and CaO. Upon the addition of Na₂CO₃, the dissolved Ca reacts to precipitate CaCO₃, and the release of silicates into the solution was significantly enhanced. This experiment confirms the reaction mechanism of Step 2—carbonation. Additionally, increasing the solution temperature from 25 to 65° C. did not significantly impact the Ca and Si concentrations, showing that the reaction mechanism is effective even at room temperature.

SEM and EDS maps were used to compare the distribution of Ca, Si, and carbon (C) in unreacted skimmed steel slag, after 10 cycles of capturing 4% CO₂ at 45° C. by the baseline and the looping methods (FIG. 4C). The Ca elemental map shows widespread distribution in all three cases from calcium-silicates, CaO, and Ca₂Fe₂O₅. Elemental mapping of C and Si reveals a higher degree of carbon mineralization by Na₂CO₃ looping than the baseline method, with C replacing Si in the slag. The SEM images show the rhombohedral shape of CaCO₃ (calcite) crystals growing from calcium-silicates.

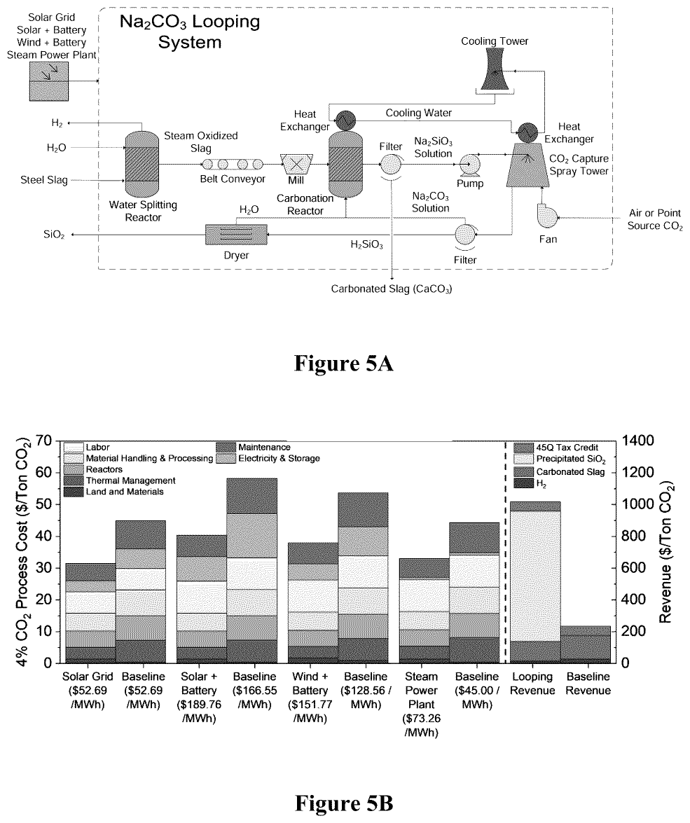

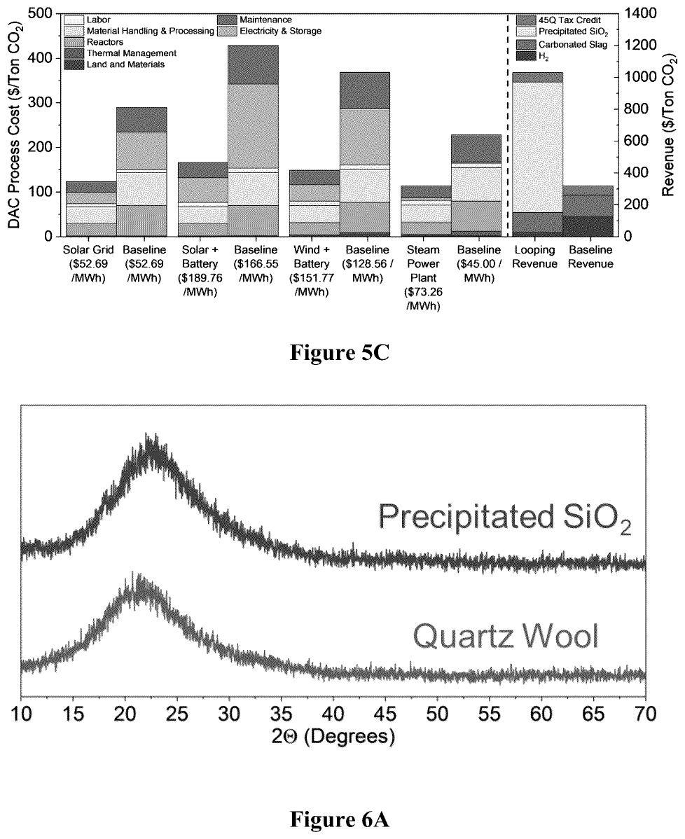

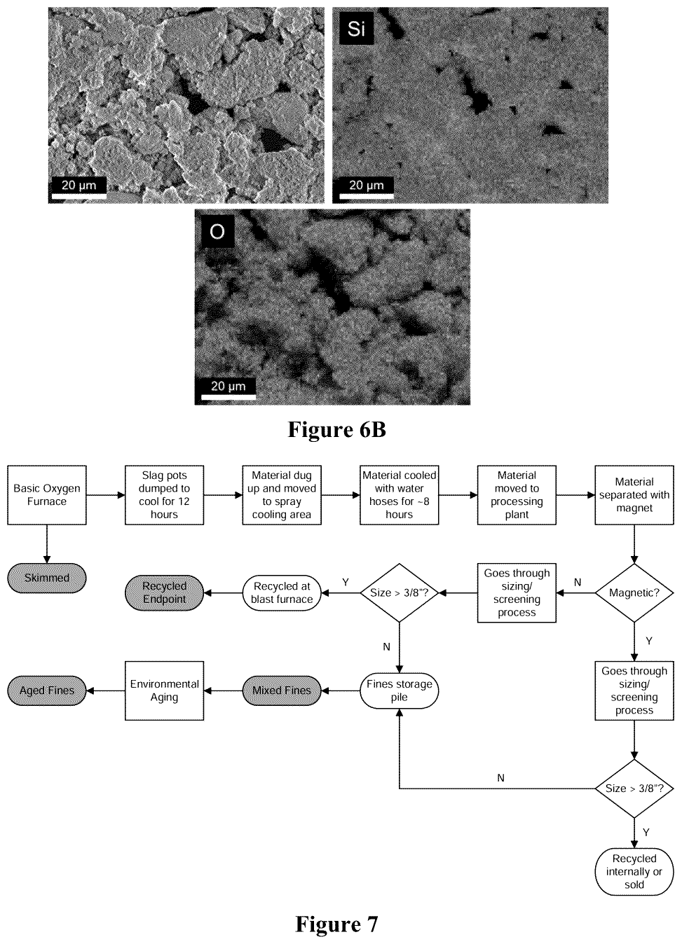

Energy and Technoeconomic Analysis. Energy and technoeconomic analysis was conducted for a preliminary plant design focused on H₂ production and CO₂ mineralization using BOF steel slag and Na₂CO₃ looping (FIG. 5A). In Step 1, a high-purity stream of H₂ mixed with unreacted H₂O is produced, which can be utilized in fuel cells or for iron ore reduction. Step 2 results in carbonated steel slag, while Steps 3 and 4 yield precipitated SiO₂, both of which can serve as supplementary cementitious materials to partially replace Portland cement in concrete. Four scenarios were analyzed in terms of energy, cost, and revenue: 1) Point source capture by Na₂CO₃ looping, 2) Point source capture by baseline method (FIG. 5B), 3) DAC by Na₂CO₃ looping, and 4) DAC by baseline method (FIG. 5C). The Na₂CO₃ looping scenarios employed the reaction equations detailed in the Process Description section. In contrast, the baseline scenarios assumed the same Step 1 but modified Steps 2 (Equation 5) and 3 (Equation 6) for CO₂ capture using only CaO in steel slag. The baseline scenarios did not include Step 4, as no SiO₂ was produced.

$$CaO ( s ) + {H}_{2} O ( l ) \to {Ca ( OH )}_{2} ( aq ) \qquad ( Eq . 5 )$$

$${Ca ( OH )}_{2} ( aq ) + {CO}_{2} ( g ) \to {CaCO}_{3} ( s ) + {H}_{2} O ( l ) \qquad ( Eq . 6 )$$

The analysis was based on experimental performance of skimmed slag at the laboratory scale for each step. The carbonation and CO₂ capture steps assumed total capture capacities of 101, 53, 62, and 12 std. mL of CO₂/g slag for point source looping, point source baseline, DAC looping, and DAC baseline, respectively. These values were derived from TGA experimental measurement of mineralization capacity of the steel slag. The amount of Na₂CO₃ was assumed to be twice the mass needed to completely react with CaSiO₃. The volume of water was calculated by assuming 90% saturation of Na₂CO₃ at 25° C. The amount of FeO in the steel slag was based on experimental H₂ production of 16.2 std. mL H₂/g slag. The system was designed to capture 100,000 tons of CO₂ annually. Any portion of slag that was not CaSiO₃ or FeO was considered inactive. Using these inputs, the mass balance was completed and reduced to mass per hour. The energy analysis considered heat balance in reactors, heat balance during material transfer between reactors, and electrical energy input to the process. The reaction temperatures for the point source Na₂CO₃ looping scenario were assumed to be 600° C., 70° C., 70° C., and 100° C. for Steps 1-4, respectively. The baseline scenario was the same without Step 4. For the DAC Na₂CO₃ looping scenario, the temperatures were assumed to be 1000° C., 25° C., 57° C., and 100° C. for Steps 1-4, respectively. The DAC baseline scenario assumed temperatures of 1000° C., 25° C., and 26° C. for Steps 1-3, respectively. Reaction times and temperatures were optimized to minimize the need for active cooling and heating. The reactions could be driven entirely by the heat of the steel slag, with only a small amount of electricity needed for milling, filtering, stirring, and pumping solutions and gases. Four energy scenarios for providing electricity were considered for each case: 1) Energy purchased from an external solar grid, 2) Internal solar photovoltaic (PV) system with integrated 16-hour battery storage, 3) Internal wind turbines with integrated 16-hour battery storage, and 4) Internal steam power plant powered by waste heat from the steel slag.

FIG. 5B shows the process cost for point source capture per ton of CO₂. It is evident that the Na₂CO₃ looping scenarios are more cost-effective than the baseline scenarios, primarily due to the lower amount of material required to capture the same amount of CO₂, leading to smaller reactors and less electricity usage. All energy sources are cost-competitive for capturing CO₂, with costs of $31.53, $40.42, $37.95, and $33.06 per ton of CO₂ captured (without including any revenues below) for solar grid, solar PV with battery storage, wind turbine with battery storage, and steam power plant, respectively. Revenues from H₂, carbonated steel slag, precipitated silica, and the 45Q tax credit were accounted for. The H₂ selling price was assumed to be $2/kg. The selling price of the point source Na₂CO₃ looping carbonated slag was assumed to be $26/ton, with other scenarios scaled based on the fraction of CO₂ mineralized; namely the less CO₂ mineralization, the lower the selling price proportionally. Precipitated silica has a selling price ranging from $600 to $1200 per ton, depending on purity. The price was set at $600 to be conservative. Finally, the 45Q tax credit provides $60/ton of CO₂ captured for projects that convert CO₂ into useful products.

FIG. 5C shows the process cost for point DAC per ton of CO₂. Again, the looping scenarios significantly outperform the baselines. Thermal management equipment (heat exchanger and cooling tower) is not needed for the solar grid, solar PV with battery, or wind turbine with battery scenarios, as the large flow rate of air can take away reaction heat. However, the steam power plant still requires it for the condenser. The DAC Na₂CO₃ looping process costs are $123.76, $166.61, $148.97, and $114.06 per ton of CO₂ captured for solar grid, solar PV with battery storage, wind turbine with battery storage, and steam power plant, respectively.

### REFERENCES

[1] Li, Peng, Hongwei Guo, Jianming Gao, Jie Min, Bingji Yan, Dong Chen, and Seshadri Seetharaman. “Novel Concept of Steam Modification Towards Energy and Iron Recovery from Steel Slag: Oxidation Mechanism and Process Evaluation.” Journal of Cleaner Production, vol. 254, 2020, 119952
[2] Moir, Graeme. “Cements.” Advanced Concrete Technology, edited by John Newman and Ban Seng Choo, Butterworth-Heinemann, 2003, pp. 3-45.
[3] U.S. Department of Energy. “Hydrogen Production.” Energy.gov, 2020, www.energy.gov/eere/fuelcells/hydrogen-production. Accessed 9 Feb. 2025.
[4] Song, Qifeng, Ming-Zhi Guo, Mingyang Zhang, and Tung-Chai Ling. “Optimization of BOFS High-Gravity Carbonation Technology: Consideration of Theoretical Guidance for Up-Scaling Applications.” Journal of Cleaner Production, vol. 469, 2024, p. 143214.
[5] Intratec. “Silicon Dioxide Prices: Historical and Current.” Intratec Solutions, https://www.intratec.us/chemical-markets/silicon-dioxide-price. Accessed 9 Feb. 2025.
[6] Carbon Capture Coalition. “Primer: 45Q Tax Credit for Carbon Capture Projects.” Carbon Capture Coalition, November 2023, https://carboncapturecoalition.org/wp-content/uploads/2023/11/45Q-primer-Carbon-Capture-Coalition.pdf. Accessed 9 Feb. 2025.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative components, compositions, and method steps disclosed herein are specifically described, other combinations of the components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A process comprising:
(a) reacting a silicate precursor with an aqueous carbonate or bicarbonate solution having an alkaline pH under conditions effective to generate a stable carbonate precipitate and soluble silicate product;
(b) reacting the soluble silicate product with carbon dioxide under conditions effective to form a soluble carbonate or bicarbonate and silicic acid; and
(c) thermally decomposing the silicic acid to produce silica and water.

2. The process of claim 1, wherein the alkaline pH comprises a pH of 8 or more, such as a pH of from 8 to 14, a pH of from 9 to 14, a pH of from 8 to 13, a pH of from 9 to 13, a pH of from 8 to 12, or a pH of from 9 to 12.

3. The process of claim 1, wherein the stable carbonate precipitate comprises calcium carbonate, magnesium carbonate, iron carbonate, or a combination thereof.

4. The process of claim 3, wherein the stable carbonate precipitate comprises calcium carbonate, magnesium carbonate, or a combination thereof.

5. The process of claim 1, wherein the stable carbonate precipitate further comprises a transition metal ion present within the silicate precursor.

6. The process of claim 1, wherein the silicate precursor is selected from the group consisting of a nesosilicate, a sorosilicate, an inosilicate (a single chain inosilicate or a double chain inosilicate), a cyclosilicate, a phyllosilicate, or a tectosilicate.

7. The process of claim 1, wherein the silicate precursor comprises a calcium silicate.

8. The process of claim 7, wherein the calcium silicate comprises wollastonite or pseudo-wollastonite.

9. The process of claim 1, wherein an aqueous carbonate or bicarbonate solution comprises aqueous sodium bicarbonate.

10. The process of claim 1, wherein the soluble silicate product comprises a sodium silicate, such as sodium metasilicate (Na₂SiO₃).

11. The process of claim 1, wherein step (a) is performed at an elevated temperature and/or pressure, such as a temperature of from greater than room temperature (20° C.) (e.g., a temperature of from greater than 20° C. to 400° C.).

12. The process of claim 11, wherein step (a) is performed at a temperature of at least 100° C., such as a temperature of from 100° C. to 400° C., a temperature of from 100° C. to 300° C., a temperature of from 150° C. to 400° C., or a temperature of from 150° C. to 300° C.

13. The process of claim 1, wherein step (b) is performed at an elevated temperature and/or pressure, such as a temperature of from greater than room temperature (20° C.) (e.g., a temperature of from greater than 20° C. to 400° C.).

14. The process of claim 13, wherein step (b) is performed at a temperature of at least 50° C., such as a temperature of from 50° C. to 400° C., a temperature of from 50° C. to 300° C., a temperature of from 50° C. to 200° C., or a temperature of from 50° C. to 100° C.

15. The process of claim 1, wherein step (c) comprises heating the silicic acid to a temperature of at least 50° C., such as a temperature of at least 80° C., or a temperature of at least 100° C.

16. The process of claim 15, wherein step (c) comprises heating the silicic acid to a temperature of from 50° C. to 200° C., such as a temperature of from 50° C. to 150° C., a temperature of from 50° C. to 100° C., a temperature of from 50° C. to 150° C., a temperature of from 50° C. to 100° C., a temperature of from 100° C. to 200° C., a temperature of from 100° C. to 170° C., or a temperature of from 100° C. to 150° C.

17. The process of claim 1, further comprising reacting a silicate feedstock material with water vapor under conditions effective to generate hydrogen gas and the silicate precursor.

18. The process of claim 17, wherein the silicate feedstock material comprises a silicate that comprises a reduced metal cation or metal (e.g., a transition metal or reduced transition metal cation such as Fe metal or an Fe²⁺ ion).

19. The process of claim 17, wherein the silicate feedstock material comprises an industrial waste product, such as steel slag or fly ash.

20. The process of claim 17, wherein the reaction of the silicate feedstock material with water vapor is performed at an elevated temperature and/or pressure, such as a temperature of from 600° C. to 900° C.
